(19) United States
(12) Patent Application Publication
(10) Pub. No.: US 2009/0143875 A1
(43) Pub. Date: Jun. 4, 2009

(54) ACTION EVALUATION APPARATUS AND METHOD

(75) Inventors: Koji KIMURA, Kawasaki-shi (JP); Hideki Kobayashi, Yokohama-shi (JP); Toshimitsu Kumazawa, Kawasaki-shi (JP); Akinori Hongu, Fujisawa-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/324,165

(22) Filed: Nov. 26, 2008

(30) Foreign Application Priority Data
Nov. 30, 2007 (JP) 2007-311065

(51) Int. Cl. G05B 13/02

(52) U.S. Cl. 700/33

(57) ABSTRACT

An action evaluation apparatus includes action detection unit which detects an action of a user, environmental load detection unit which detects a load on an environment which is caused by the action, first storage unit which stores identification information of the action and the detected load in correspondence with each other, overload action detection unit which detects a first action which has caused a load exceeding a threshold, load adjusting unit which adjusts the load which is caused by the first action and a load which is caused by a second action stored in the first storage, and second storage unit which stores the adjusted load in correspondence with the identification information of the action.

### CROSS-REFERENCE TO RELATED APPLICATIONS

This application is based upon and claims the benefit of priority from prior Japanese Patent Application No. 2007-311065, filed Nov. 30, 2007, the entire contents of which are incorporated herein by reference.

### BACKGROUND OF THE INVENTION

1. Field of the Invention

The present invention relates to an action evaluation apparatus which evaluates the environmental loads caused by the daily life actions of users.

2. Description of the Related Art

As is generally known, under the Kyoto protocol, Japan is required to reduce CO₂ emission by 6% from the 1990 level before 2012. Currently, however, the CO₂ emission amount is on the increase. Considering each sector will reveal that the situation in the household/office sector is severe. In this situation, approaches to reduction in environmental load in homes include, for example, improving the energy efficiencies of devices themselves, implementing automatic control of devices using passive infra-red motion sensors, and improving the awareness of users by presenting information based on environmental load amounts.

As an approach to the presentation of information, conventionally, there have been proposed a system which provides action advices by evaluating the power consumption amount of a home distribution panel breaker or individual device (see, e.g., JP-A 2003-162787), a system which presents the environmental load totalized for each action category (see, for example, JP-A 2006-058942), and the like.

These conventional systems measure and totalize a power consumption amount for each device operated by a user, and give the user advice on energy saving on the basis of the totalization result. For this reason, a problem of such a conventional system is that the system lacks in accuracy in advice on the action pattern of a user, even though it can give advice on the operation of each device.

### BRIEF SUMMARY OF THE INVENTION

The present invention has been made to solve the above problem, and has as its object to provide an action evaluation apparatus which can evaluate the action pattern of a user more accurately.

An aspect of the present invention is provides an action evaluation apparatus comprising, action detection unit which detects an action of a user, environmental load detection unit which detects a load on an environment which is caused by the action, first storage unit which stores identification information of the action and the detected load in correspondence with each other, overload action detection unit which detects a first action which has caused a load exceeding a threshold, load adjusting unit which adjusts the load which is caused by the first action and a load which is caused by a second action stored in the first storage, and second storage unit which stores the adjusted load in correspondence with the identification information of the action.

### BRIEF DESCRIPTION OF THE SEVERAL VIEWS OF THE DRAWING

FIG. 1 is a circuit block diagram showing the arrangement of an action evaluation apparatus according to an embodiment;

FIG. 2 is a view showing an example of the determination table stored in an action identification unit shown in FIG. 1;

FIG. 3 is a view showing an example of the action data stored in an action/environmental load database unit shown in FIG. 1;

FIG. 4 is a flowchart showing processing by an environmental load distribution unit in FIG. 1;

FIG. 5 is a flowchart showing processing by the environmental load distribution unit shown in FIG. 1;

FIG. 6 is a view showing the determination result obtained by the environmental load distribution unit shown in FIG. 1;

FIG. 7 is a view showing an example of the environmental impacts obtained by the processing shown in FIG. 5;

FIG. 8 is a flowchart showing processing by the environmental load distribution unit shown in FIG. 1;

FIG. 9 is a view showing an example of the environmental load to be distributed which is obtained by the processing shown in FIG. 8;

FIG. 10 is a view showing an example of the distribution ratios obtained by the processing shown in FIG. 8;

FIG. 11 is a view showing an example of the distributed environmental loads obtained by the processing shown in FIG. 8;

FIG. 12 is a flowchart showing processing by an advice selection unit shown in FIG. 1;

FIG. 13 is a view for explaining processing by the advice selection unit shown in FIG. 1;

FIG. 14 is a view for explaining processing by the advice selection unit shown in FIG. 1; and

FIG. 15 is a view for explaining processing by the advice selection unit shown in FIG. 1.

### DETAILED DESCRIPTION OF THE INVENTION

An embodiment of the present invention will be described below with reference to the views of the accompanying drawing.

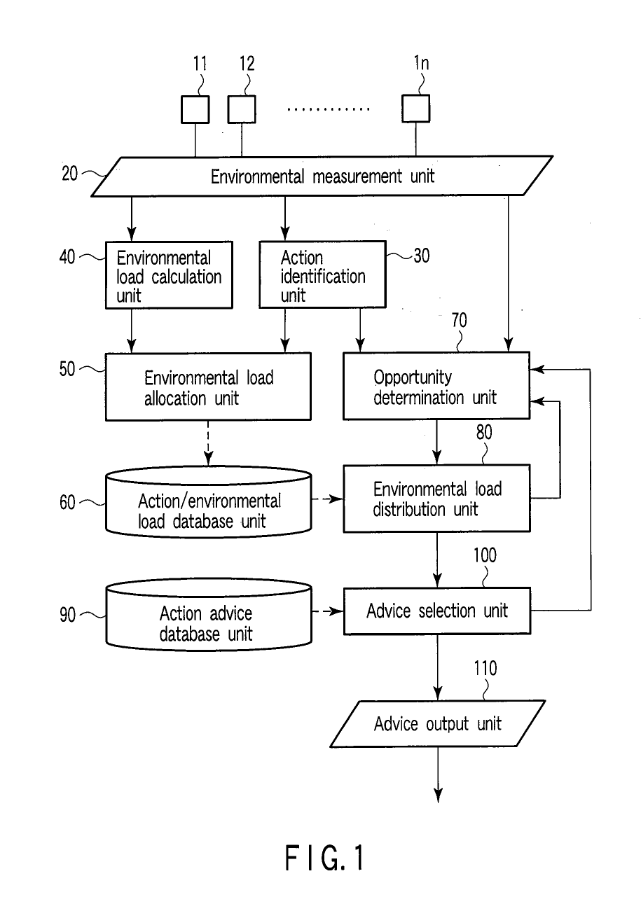

FIG. 1 shows the arrangement of an action evaluation apparatus according to an embodiment of the present invention. This action evaluation apparatus performs action evaluation targeted to people (users) belonging to one community, e.g., a group of cohabiting people who are scattered in one building, such as a house, an office, or a school dormitory, or a group of people who are scattered in an area of a predetermined range, e.g., a municipality such as a city, town, or village. Note that in the following description, energy includes, for example, electricity and gas.

As shown in FIG. 1, this action evaluation apparatus includes sensors 11 to 1n, an environmental measurement unit 20, an action identification unit 30, an environmental load calculation unit 40, an environmental load allocation unit 50, an opportunity determination unit 70, an action/environmental load database unit 60, an environmental load distribution unit 80, an action advice database unit 90, an advice selection unit 100, and an advice output unit 110.

The following description exemplifies a case in which this action evaluation apparatus is installed in a general home. In addition, the environmental measurement unit 20, action identification unit 30, environmental load calculation unit 40, environmental load allocation unit 50, opportunity determination unit 70, environmental load distribution unit 80, and advice selection unit 100 can be implemented by a microprocessor and a storage medium storing control programs for causing the processor to operate. The action/environmental load database unit 60 and the action advice database unit 90 can be implemented by a storage medium such as a semiconductor memory or hard disk. The advice output unit 110 is an interface which outputs signals to a monitor, loudspeaker, television set, and the like.

The sensors 11 to 1n are sensors, e.g., a pyroelectric sensor, ultrasonic sensor, pressure sensor, and receiver, which detect the actions of users and the state of a living environment, and are placed at positions near the users in the home. Note that the above receiver receives a signal from a radio-frequency identification (RFID) tag attached to a user or article.

The sensors 11 to 1n are also measuring instruments which are placed on the respective breakers of the distribution panel, a gas meter, and a water meter to detect a power consumption and the amounts of gas and city water (wastewater flow rate) used, or sensors which detect a date and time, weather, temperature, humidity, atmospheric pressure, and the like. Alternatively, it suffices to acquire information about weather, temperature/humidity, atmospheric pressure, and the like from the Internet via a communication line.

A more concrete example of an application of the sensors 11 to 1n is that if, for example, the community is a home, pressure sensors and receivers are respectively placed on a ceiling and wall within the action range of a user and in rooms for specific purposes (e.g., a living room, kitchen, bathroom, rest room, lavatory, balcony, and entrance), and an RFID tag is attached to the user or an article in the house so as to be used to specify the whereabouts and action of the user. In addition, as the above sensors, the opening/closing switch of a door and a water flowmeter near a faucet can be used to specify the action of the user.

The environmental measurement unit 20 includes a timepiece function for counting the current date and time. The environmental measurement unit 20 totalizes the detection results obtained by the sensors 11 to 1n in correspondence with the counted time information in real time (e.g., in a cycle of one second), and outputs the totalization result as measurement data.

The sensors 11 to 1n and the environmental measurement unit 20 can be connected to each other via a wired LAN or wireless LAN installed in the home. The sensors 11 to 1n can be mounted in various kinds of electrical devices (e.g., a television set, refrigerator, washing machine, and lighting fixture) to allow the electrical devices to function as network home electrical appliances, and can be connected to the environmental measurement unit 20 via a network. Furthermore, as the sensors 11 to 1n, digital cameras can be used, and the environmental measurement unit 20 can totalize image data captured by the digital cameras.

The action identification unit 30 acquires measurement data from the environmental measurement unit 20, and detects the user position (the place where a user stays) and the type of action of each user on the basis of the acquired data and the determination table stored in advance.

If, for example, the power supplies of electrical devices which have not been used change to the on state or the power supplies of electrical devices which have been used change to the off state, the sensors 11 to 1n detect these changes in state. The environmental measurement unit 20 totalizes the detection results together with the detection results obtained by other sensors 11 to 1n. The action identification unit 30 acquires the resultant data as measurement data. The action identification unit 30 then detects the identification information of each electrical device whose power supply state has changed, specifies the user position, and determines the action of the user on the basis of the above measurement data.

A plurality of users are identified by receiving pieces of identification information from the RFID tags attached to the respective users or performing image analysis on the basis of image data or the like. The user position is determined by detecting the position where a receiver which has received the above identification signal is placed or the position where a digital camera which has output image data is placed. The action of each user is then determined by combining the detection result obtained by one of the sensors 11 to 1n which is placed near the position where the above position is detected, the operation state of the electrical device, and the like.

If, for example, the community is a home, the action types of a user can be, “sleeping”, “eating”, “cooking”, “bathing”, “toileting”, “cleaning”, “dressing”, “TV watching”, “operating PC”, “playing game”, “relaxing”, and the like. The action identification unit 30 determines to which one of these actions the action of the user corresponds.

Assume that a pressure sensor is placed as the sensor 11 on a bed, and the sensor 12 which detects the on/off state of a lighting in the bed room is placed. In this case, if the sensor 11 reacts and the sensor 12 detects that the lighting is turned off, “sleeping” is detected as the type of action.

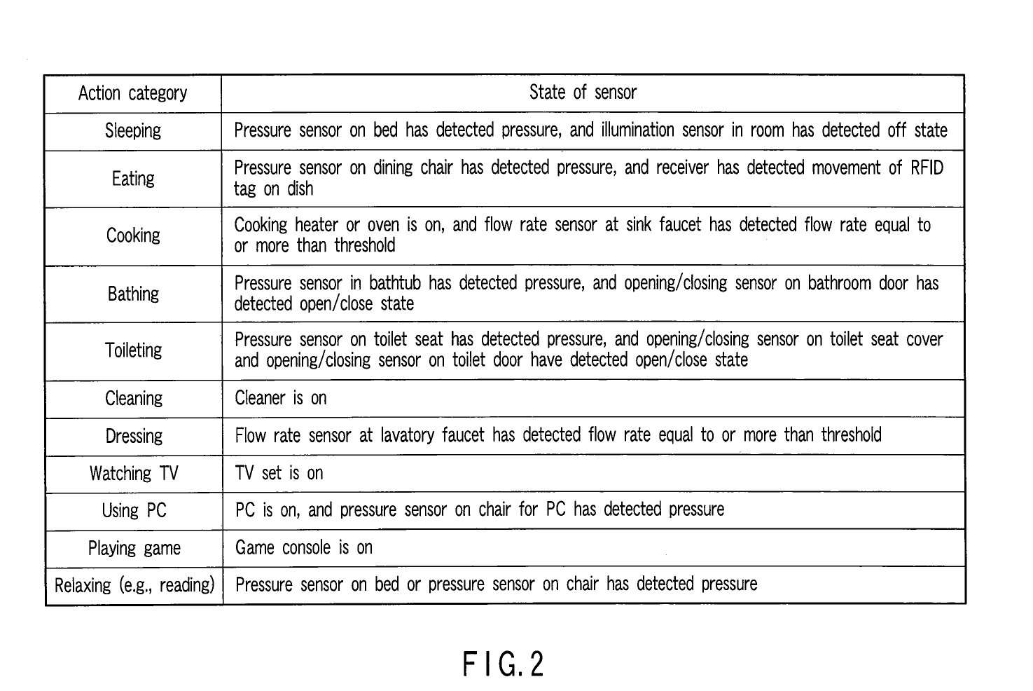

Such action determination by the action identification unit 30 is performed on the basis of, for example, a determination table like that shown in FIG. 2. If the community is a home, the pieces of identification information of a plurality of action categories to be detected are made to correspond to measurement data (the pieces of identification information of related sensors, detection results on them, detection results on the user positions, and the like) as a condition for the determination of the respective action categories.

The environmental load calculation unit 40 calculates an environmental load by applying a conversion coefficient to each preset environmental load at preset intervals (e.g., every one min) on the basis of the measurement data (the amount of electricity, gas, or city water used) totalized by the environmental measurement unit 20, and outputs the calculation result as environmental load data to the environmental load allocation unit 50.

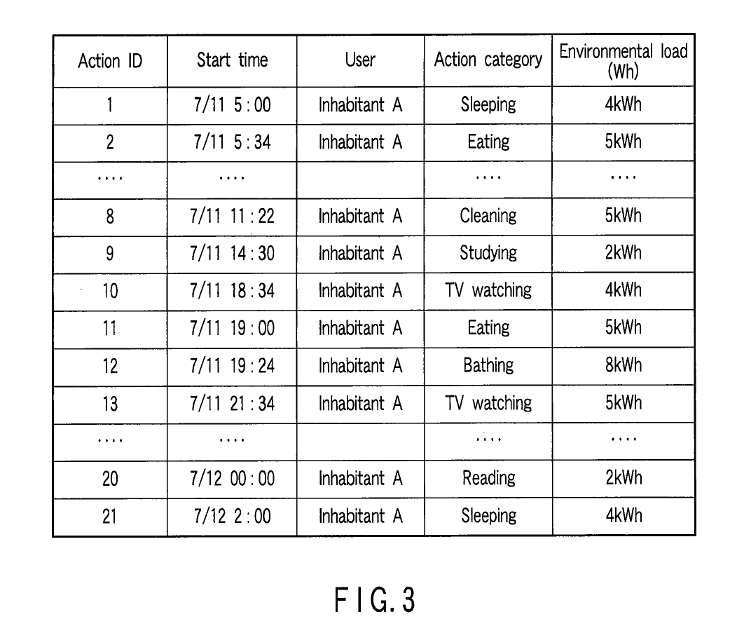

The environmental load allocation unit 50 acquires the detection result (the user position and the action type) obtained by the action identification unit 30 and the environmental load data from the environmental load calculation unit 40, and issues action IDs for the respective users in chronological order. The environmental load allocation unit 50 then generates action data at this point of time in correspondence with the action IDs, in which the action types are made to correspond to the environmental load data, and records the data in the action/environmental load database unit 60. Assume that chronological time information to be associated is obtained by detecting the time when the action type has changed as “start time (end time)”. FIG. 3 shows an example of such data. FIG. 3 shows only power consumption amounts as environmental load data.

The opportunity determination unit 70 acquires the time information counted by the environmental measurement unit 20 and the current action type of each user from the action identification unit 30, and determines the necessity to provide advice information for each user on the basis of these pieces of information. If it is necessary, the opportunity determination unit 70 determines an extraction condition for the extraction of a date and time for providing an advice and base data for action evaluation from the action/environmental load database unit 60.

More specifically, a date and time for providing an advice is determined on the basis of the result of a comparison between the current date and time and a preset advice provision timing (e.g., every hour or every 7 a.m.) or in accordance with the action type of the user in a predetermined time in the past. The user may not recognize a provided advice depending on the current action type. For this reason, the time for the provision of an advice is adjusted in accordance with the action type.

An extraction condition for base data for action evaluation is determined in consideration of a date and time, weather, indoor temperature, average outdoor temperature, and the like. For example, acquiring information indicating that the current date and time is August 13, 9 a.m., the weather is fair, and the average outdoor temperature is 28° C., the opportunity determination unit 70 determines an extraction condition such that, for example, an interval condition is set to “August”, a weather condition is set to “fair”, and an average outdoor temperature condition is set to “25° C. to 30° C.”.

Upon receiving a request to review an extraction condition from the environmental load distribution unit 80 (to be described later) or the advice selection unit 100 because the base data used for processing up to advice selection is too small in amount, the opportunity determination unit 70 determines an extraction condition again by reviewing the extraction condition so as to allow more data to be used, even after the determination of the extraction condition. For example, in the above case, the extraction condition is executed so as to allow the use of more data such that the interval condition is “summer” and the average outdoor temperature is “20° C. to 30° C.”. Note that if the condition cannot be reviewed after repetitive reviewing of the condition, the corresponding information is notified to the environmental load distribution unit 80 or the advice selection unit 100.

The environmental load distribution unit 80 reads past action data of a user as an evaluation target which matches the extraction condition determined by the opportunity determination unit 70 from the action/environmental load database unit 60, and calculates the impact relationship between action categories for each action category on the basis of the read past action data. The environmental load distribution unit 80 then distributes (adjusts) the respective environmental load data allocated by the environmental load allocation unit 50 for the current action data as evaluation targets on the basis of the calculated impact relationship, and totalizes the environmental load data after distribution for each action category.

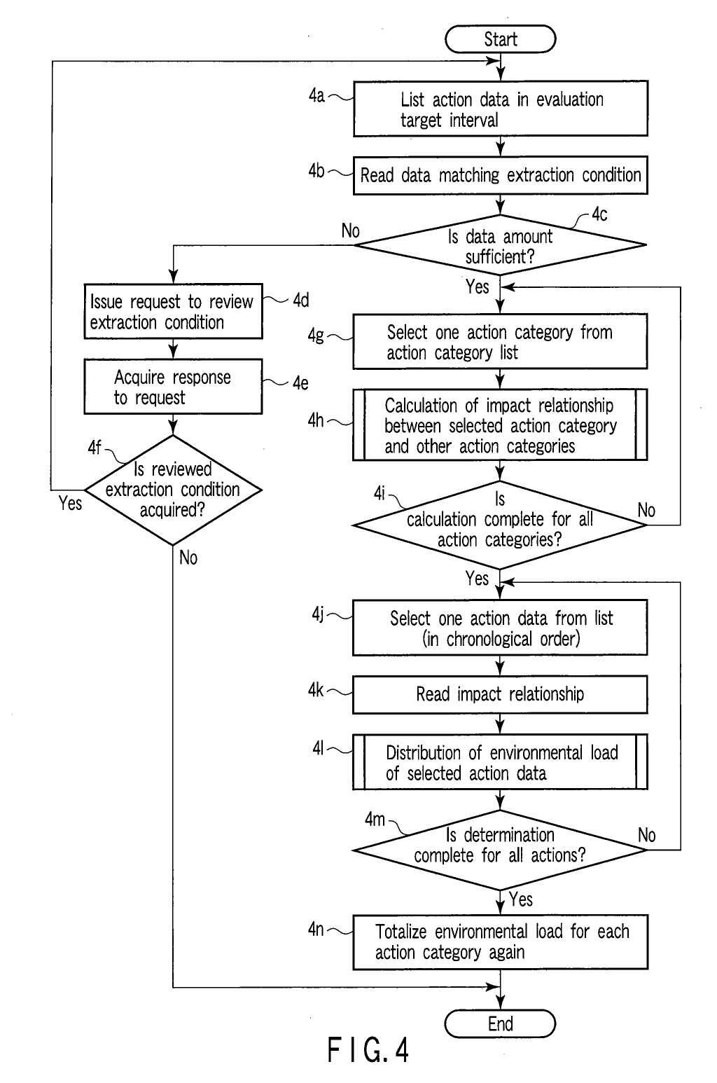

Processing by the environmental load distribution unit 80 will be described with reference to FIG. 4. FIG. 4 is a flowchart showing the processing by the environmental load distribution unit 80.

First of all, in step 4a, the environmental load distribution unit 80 reads and lists action data corresponding to an interval in which evaluation is performed from the action/environmental load database unit 60. The process then shifts to step 4b.

In step 4b, the environmental load distribution unit 80 reads past action data of a user as an evaluation target which matches the extraction condition determined by the opportunity determination unit 70 from the action/environmental load database unit 60. The process then shifts to step 4c.

In step 4c, the environmental load distribution unit 80 determines whether the data amount read in step 4b is sufficient to calculate an impact relationship to be described later. If YES in step 4c, the process shifts to step 4g. If NO in step 4c, the process shifts to step 4d. Note that whether the data amount is sufficient is determined by, for example, checking whether the amount exceeds a preset threshold.

In step 4d, the environmental load distribution unit 80 issues a request to review the extraction condition to the opportunity determination unit 70. The process then shifts to step 4e.

In step 4e, the environmental load distribution unit 80 acquires a response to the request issued in step 4d from the opportunity determination unit 70. The process then shifts to step 4f.

In step 4f, the environmental load distribution unit 80 determines whether the response acquired in step 4e is the reviewed extraction condition. If the acquired response is the reviewed extraction condition, the process shifts to step 4b. If the acquired response is not the reviewed extraction condition, i.e., the notification indicates that no review can be made, this processing is terminated without distribution of environmental load data.

In step 4g, the environmental load distribution unit 80 selects one of many action categories as shown in FIG. 2. The process then shifts to step 4h.

In step 4h, the environmental load distribution unit 80 calculates the impact relationship between the action category selected in step 4g and another action category on the basis of the past action data of the user as the evaluation target which is read in step 4b. The process then shifts to step 4i.

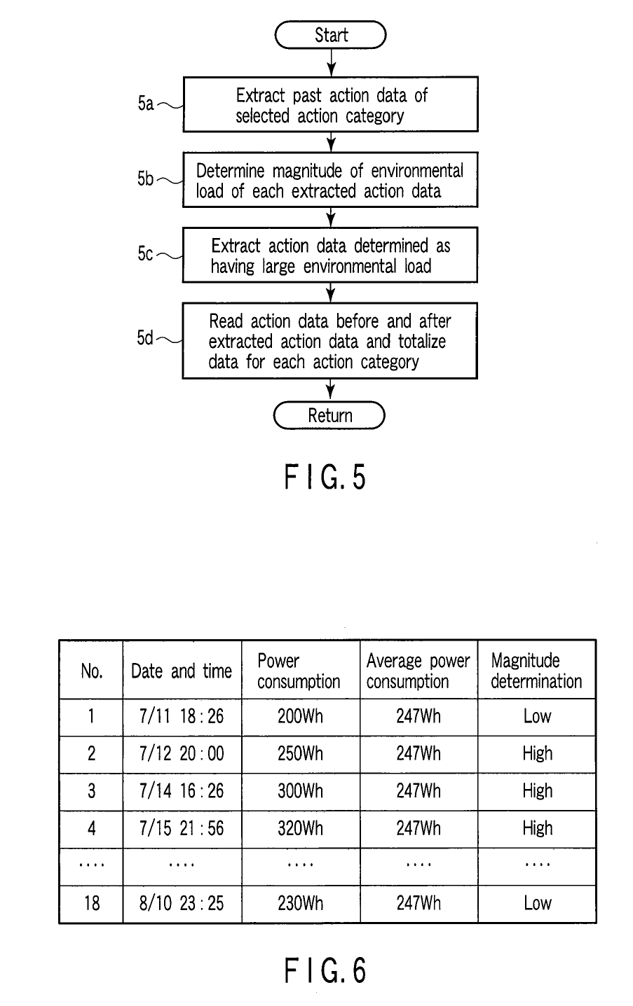

The processing in step 4h will be described below with reference to FIG. 5.

In step 5a, the environmental load distribution unit 80 extracts the action data of the action category selected in step 4g of the past action data of the user as the evaluation target which is read in step 4b. The process then shifts to step 5b.

In step 5b, the environmental load distribution unit 80 calculates the average value of the environmental load data of the action data extracted in step 5a, and compares the average value with each of the environmental load data of the action data extracted in step 5a to determine which is larger. The process then shifts to step 5c. FIG. 6 shows an example of the processing result obtained in step 5b.

Note that this processing is described as the processing of calculating an average value. However, it suffices to use, as a threshold for the above determination, environmental load data corresponding to the median of the environmental load data of the action data extracted in step 5a instead of the above average value. That is, it suffices to use, as the above threshold, a standard value based on past data, separately totalized statistic, or the like instead of an average value.

In step 5c, the environmental load distribution unit 80 extracts action data determined as corresponding to environmental load data larger than the average value on the basis of the determination result obtained in step 5b. The process then shifts to step 5d.

In step 5d, the environmental load distribution unit 80 reads five action data immediately before the action data extracted in step 5c from the action/environmental load database unit 60. That is, the environmental load distribution unit 80 reads the action data of five actions performed immediately before the action corresponding to the action data extracted in step 5c from the action/environmental load database unit 60.

The environmental load distribution unit 80 then totalizes the number of action data read in step 5d for each action category in correspondence with each action category of action data (=each action category selected in step 4g) extracted in step 5c, and records the resultant data as an impact relationship on the action/environmental load database unit 60. The process then shifts to step 4i.

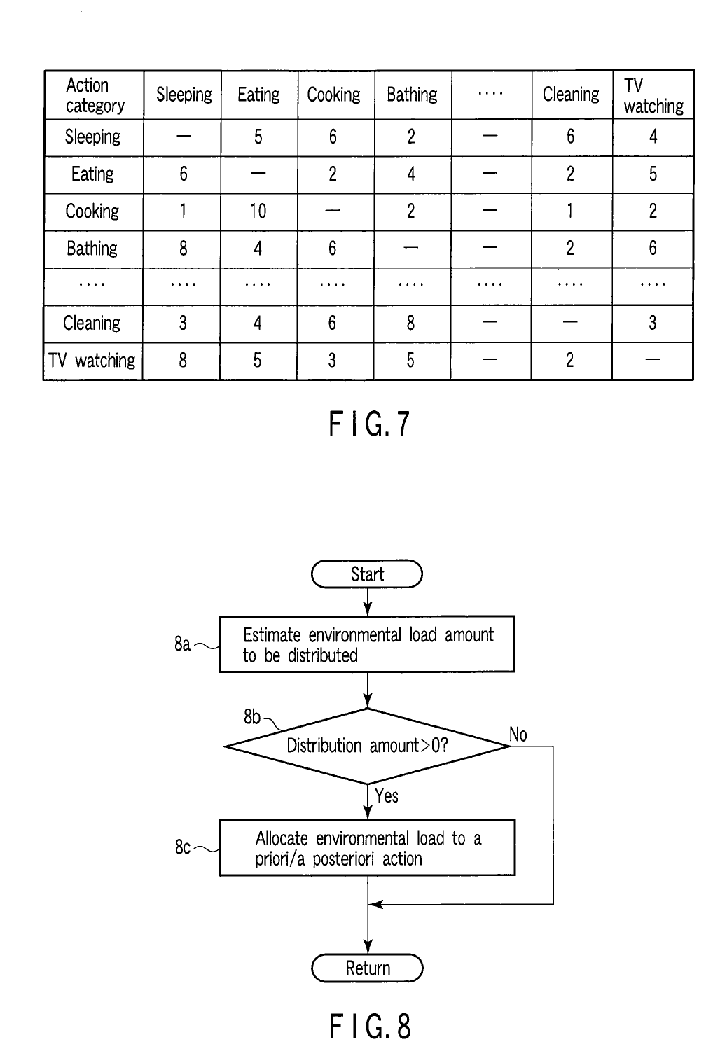

Executing the processing in steps 4g and 4h for each action category will obtain, for example, a totalization result (impact relationship) like that shown in FIG. 7. That is, this totalization result indicates the relationship between the action categories and the five action categories executed before it under the extraction condition determined by the opportunity determination unit 70. Note that FIG. 7 shows an impact relationship in which the action categories in the column of the table impact the action categories in the row.

Note that the following method of calculating the above impact relationship may be used. In steps 5c and 5d, for example, a statistic method such as the quantification method of the second type is used to calculate the impact quantity of an explanatory variable to a response variable by setting the determination result on each action data in step 5b to the response variable (high=1; low=0) and using an a priori action corresponding to each action data as the explanatory variable. This value can be used as an impact relationship.

In step 4i, the environmental load distribution unit 80 determines whether impact relationships have been calculated for all the action categories. If YES in step 4i, the process shifts to step 4j. If NO in step 4i, the process shifts to step 4g to calculate an impact relationship with the remaining action category.

In step 4j, the environmental load distribution unit 80 selects one action data from the action data listed in step 4a in chronological order. The process then shifts to step 4k.

In step 4k, the environmental load distribution unit 80 reads an impact relationship corresponding to the action category of the action data selected in step 4j from the action/environmental load database unit 60. The process then shifts to step 4l.

In step 4l, the environmental load distribution unit 80 distributes the environmental load data of the action data selected in step 4j to the action data listed in step 4a on the basis of the impact relationship read in step 4k. The process then shifts to step 4m.

The processing in step 4l will be described with reference to FIG. 8.

In step 8a, the environmental load distribution unit 80 estimates the load amount (=load amount to be distributed) caused by the impact of another action performed in advance, of the environmental load data of the action data selected in step 4j, on the basis of the impact relationship read in step 4k. The process shifts to step 8b. This load amount will be referred to as a distribution amount hereinafter.

The above distribution amount is set as the amount by which the environmental load data of the action data selected in step 4j exceeds the average value of the same action category obtained in step 5b, and is regarded as an environmental load amount by which the environmental load exceeds usual average environmental load data due to an impact from another action.

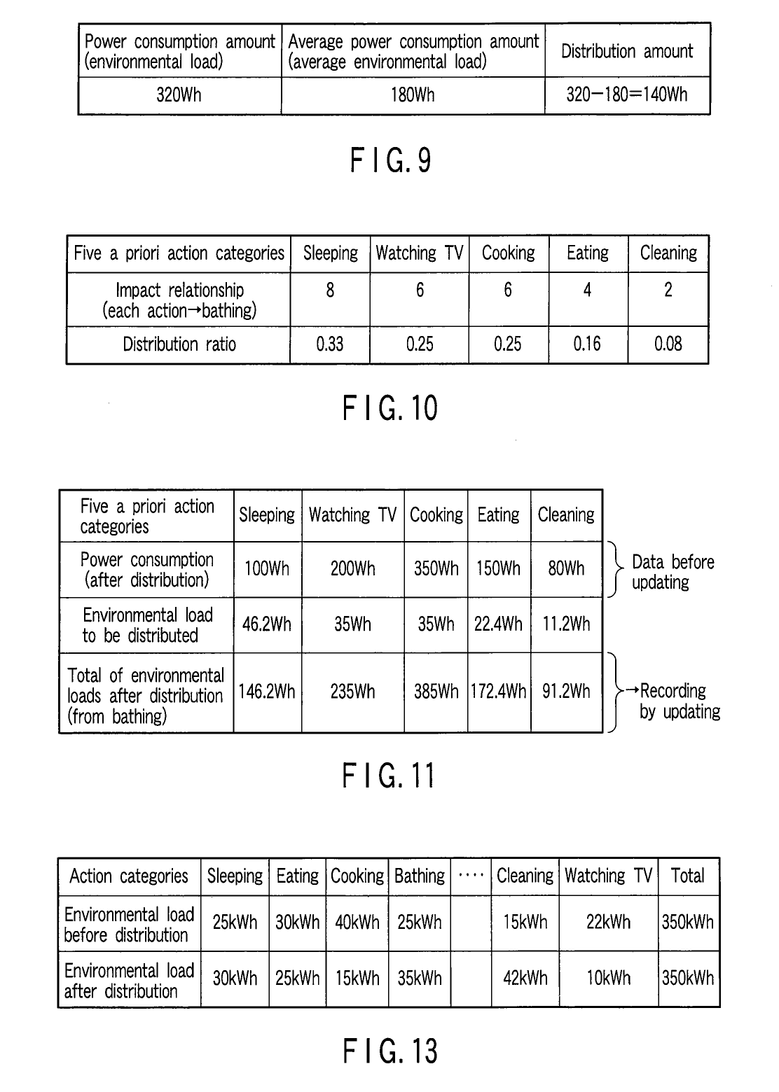

This processing will be described by exemplifying “bathing” as an action category. Assume that as shown in FIG. 9, 320 Wh is recorded as environmental load data (=power consumption amount) in correspondence with the action data of “bathing”. In this case, if the average value of the action category “bathing” obtained in step 5b is 180 Wh, the difference, i.e., a power consumption amount of 140 Wh, is regarded as an environmental load caused by another action, and is set as a distribution amount.

In step 8b, the environmental load distribution unit 80 determines whether the distribution amount estimated in step 8a is larger than 0, i.e., there is a load amount to be distributed. If the distribution amount is larger than 0, the process shifts to step 8c. If the distribution amount is 0, the process shifts to step 4m.

In step 8c, the environmental load distribution unit 80 calculates distribution ratios corresponding to time weights indicating the temporal distances between the impact relationship read in step 4k and the action data selected in step 4j for the five a priori action data of the action data selected in step 4j of the action data listed in step 4a.

The environmental load distribution unit 80 adds the distribution amounts calculated in step 8a to the environmental load data of the five a priori action data on the basis of the distribution ratios, and records by updating the environmental load data of each action data on the action/environmental load database unit 60. The process then shifts to step 4m. Note that if the number of a priori action data as distribution targets is less than five, the process shifts to step 4m without performing distribution.

Assume that there are actions corresponding to the action categories “sleeping”, “watching TV”, “cooking”, “eating”, and “cleaning” before “bathing” in consideration of the case shown in FIG. 9, as shown in FIG. 10. In this case, for the sake of a concise description, a description of weighting with temporal weights will be omitted. Since the impact relationship between the respective actions read in step 4k and “bathing” is represented by “sleeping”:“TV watching”:“cooking”:“eating”:“cleaning”=8:6:6:4:2, a power consumption amount of 140 Wh is distributed in accordance with these ratios as distribution ratios.

With this operation, as shown in FIG. 11, the distributed environmental loads are added to values recorded as environmental load data (=power consumption amounts) in the respective action data, and the addition results are recorded as the environmental load data of the respective action data on the action/environmental load database unit 60.

In step 4m, the environmental load distribution unit 80 determines whether the necessity of distribution has been determined for all the action data listed in step 4a. If YES in step 4m, the process shifts to step 4n. If NO in step 4m, the process shifts to step 4j to execute the above necessity determination for the remaining action data.

In step 4n, the environmental load distribution unit 80 totalizes the total amount of environmental load data for each action category on the basis of action data, of the action data stored in the action/environmental load database unit 60, which corresponds to a preset interval (e.g., one week), and terminates this processing.

According to the above description, the impact relationship between action data is determined on the basis of the five a priori action data. However, it suffices to determine an impact relationship on the basis of five a posteriori action data according to the same idea as described above. In addition, environmental loads may be distributed to a posteriori actions as well as a priori actions by calculating distribution ratios in consideration of the impact relationship between action categories corresponding to the a posteriori actions. When such distribution is to be performed, in order to prevent any environmental load amounts distributed once from being distributed to other action data again, any environmental load amounts distributed once are excluded from computation targets so as not to be handled as load amounts caused by the impact of other actions in step 8a.

The action advice database unit 90 stores a plurality of action advice data in which the IDs of advices, action categories, advice data associated with reductions in environmental load, presentation conditions for determination of whether to present the information of the data to a user, and priority information indicating priority levels within the same action category are made to correspond to each other. Note that the system designer sets the contents of action advice data to be stored in the action advice database unit 90 in advance.

The advice selection unit 100 compares the environmental load data totalized by the environmental load distribution unit 80 for each action category with the presentation condition for the action advice data recorded on the action advice database unit 90, and selects an advice to be presented from the action advice data in accordance with the comparison result and the priority information of the action advice data. The advice selection unit 100 then presents this advice to the user via the advice output unit 110.

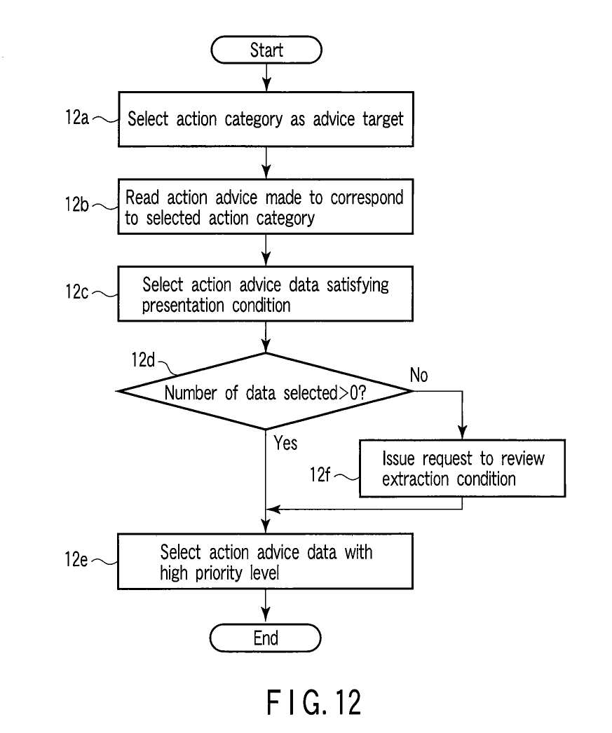

The processing by the advice selection unit 100 will be described with reference to FIG. 12. FIG. 12 is a flowchart showing the processing by the advice selection unit 100.

In step 12a, the advice selection unit 100 selects an action category as an advice target by referring to the environmental load data (and further, environmental load data before distribution) totalized by the environmental load distribution unit 80 for each action category. The process then shifts to step 12b.

As a selection criterion used by the advice selection unit 100 in step 12a, there is available a method of selecting an action category corresponding to the largest environmental load after distribution, a method of comparing an environmental load before distribution with an environmental load after distribution for each action category and selecting an action category corresponding to the largest increase or a high increase ratio after distribution, or the like. Using any one of these methods will select an action category corresponding to an environmental load which is rapidly increased by a special life action as compared with a usual life action.

This processing will be described with reference to a specific example. Assume that the totalization results shown in the lower row in FIG. 13 have been obtained by distribution by the environmental load distribution unit 80 with respect to the measurement results on environmental loads before distribution by the environmental load distribution unit 80. The advice selection unit 100 selects “cleaning” as an action category in the case shown in FIG. 13 with respect to such a result regardless of any one of the above selection criteria to be used.

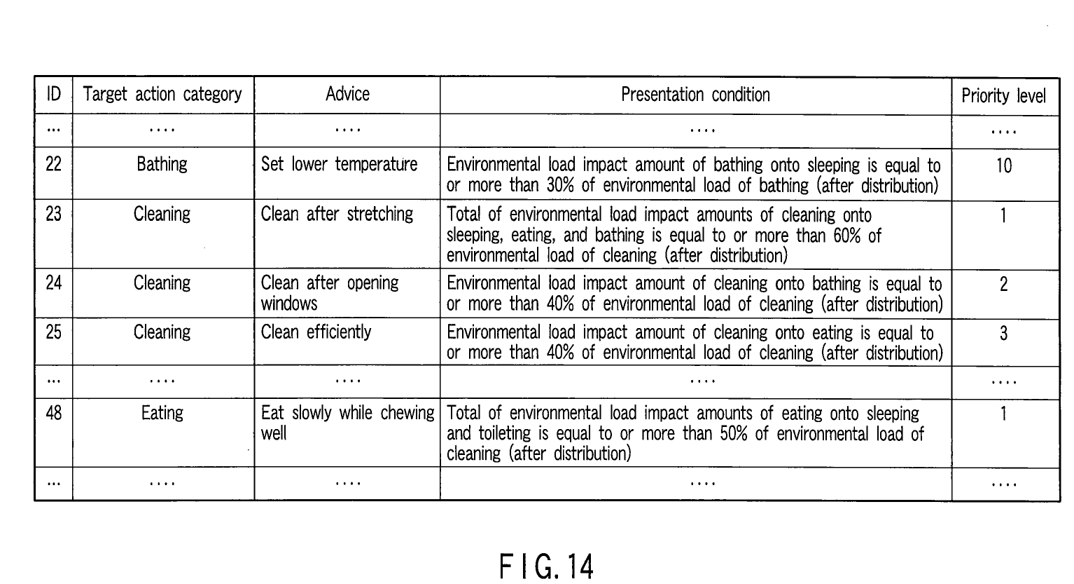

In step 12b, the advice selection unit 100 reads the action advice data of the action category selected in step 12a from the action advice database unit 90. The process then shifts to step 12c. That is, in the case shown in FIG. 13, since “cleaning” is set as an action category, if, for example, action advice data like that shown in FIG. 14 is set in the action advice database unit 90, action advice data with the IDs “23”, “24”, and “25” corresponding to the action category “cleaning” are selected.

In step 12c, the advice selection unit 100 selects action advice data including a presentation condition which is satisfied from the action advice data read in step 12b. The process then shifts to step 12d.

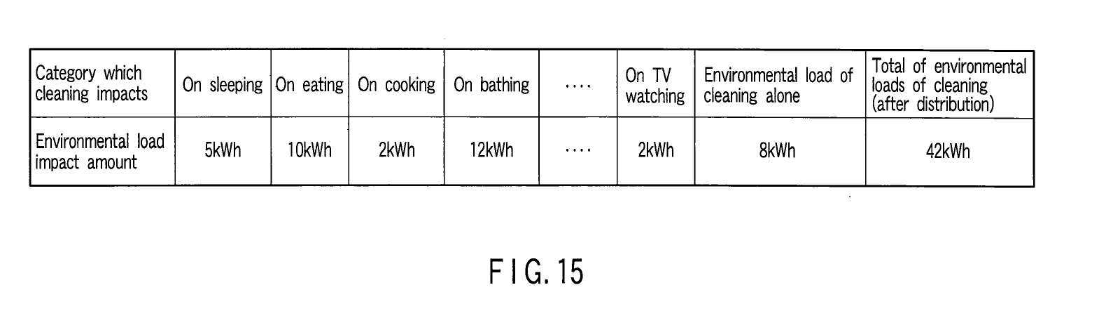

Assume that FIG. 15 shows the breakdown of environmental loads which the action “cleaning” gave to other action categories. Advices corresponding to the action “cleaning” are the advices with ID=23, 24, and 25 in FIG. 14. Since only the presentation condition for the advice with ID=23 of these advices is satisfied, only this advice is selected. This is because, the total of environmental load impact amounts which “cleaning” gave to “sleeping”, “eating”, and “bathing” is 5 kWh+10 kWh+12 kWh=27 kWh, and the total of environmental loads of “cleaning” after distribution is 42 kWh. Therefore, the ratio between the environmental load impact amounts which “cleaning” gave to “sleeping”, “eating”, and “bathing” is 27/42=about 0.64. That is, the ratio is equal to or more than 60%, which satisfies the presentation condition for the advice with ID=23. When the remaining two advices are determined in the same manner with the values shown in FIG. 15, the presentation conditions are not satisfied.

Note that the advice data set for the action advice data with ID=23 is an advice based on the assumption that “since the user became tired after cleaning, the environmental loads of the actions “sleeping”, “eating”, and “bathing” executed after “cleaning” increased than usual”.

In step 12d, the advice selection unit 100 determines whether there is one or more action advice data selected in step 12c, i.e., action advice data which satisfy the presentation conditions. If YES in step 12d, the process shifts to step 12e. If NO in step 12d, the process shifts to step 12f.

In step 12e, the advice selection unit 100 selects action advice data for which the highest priority level is set by referring to the priority information contained in the respective action advice data selected in step 12c, and outputs the contained advice data to the advice output unit 110. The advice selection unit 100 then terminates this processing.

In the case shown in FIGS. 13 and 14, since only the action advice data with ID=23 is action advice data which satisfies the presentation condition, this action advice data is automatically output. If, for example, the action advice data with the IDs “24” and “25” are selected in step 12c, the action advice data with ID=24 which has a higher priority level is output in step 12e.

In step 12f, the advice selection unit 100 issues a request to review the extraction condition to the opportunity determination unit 70, and terminates this processing.

According to the above description, one action category is selected, and one advice is given. However, it suffices to give a plurality of advices (select a plurality of advices in step 12e) for one action category or to execute the processing shown in FIG. 12 for each of a plurality of action categories and give advices for the respective action categories.

The advice output unit 110 acquires advice data from the advice selection unit 100 and presents the advices based on the data to the user visually or auditorily or both. As an output device for advices, for example, a dedicated monitor, a loudspeaker, a TV set, or a personal computer is used, and the advice output unit 110 includes a corresponding interface.

As described above, if an environmental load due to a given action of a user is larger than a usual (average) load, the action evaluation apparatus having the above arrangement adjusts the environmental loads measured between the environmental loads measured from the action and the environmental load measured from other actions, and distributes the environmental loads to the environmental loads of actions which are the main causes of an increase in environmental load. That is, if an environmental load larger than a usual load is measured, the apparatus distributes the environmental loads respectively generated by a plurality of actions in accordance with the relationship between the actions.

Therefore, the action evaluation apparatus having the above arrangement detects the environmental load distributed in consideration of the relationship between actions for each action category, and hence can evaluate the action pattern of the user more accurately on the basis of this detection result.

Note that the present invention is not limited to the above embodiments, and constituent elements can be variously modified and embodied at the execution stage within the spirit and scope of the invention. Various inventions can be formed by proper combinations of a plurality of constituent elements disclosed in the above embodiments. For example, several constituent elements may be omitted from the all the constituent elements in each embodiment. In addition, constituent elements of the different embodiments may be combined as needed.

For example, the above embodiment has exemplified the case in which an action type such as “cleaning” performed before an action type such as “bathing” is regarded as the cause of the prolongation of the action type, the environmental load by which the environmental load caused by “bathing” exceeds the average environmental load is distributed to “cleaning” or the like. That is, the environmental load of an a posteriori action which is larger than a usual environmental load is distributed as the environmental load of an a priori action.

In some case, instead of an action type such as “cleaning” itself, performing “cleaning” for a time longer than usual may prolong the a posteriori action “bathing” as compared with usual bathing. Therefore, unlike the above embodiment in which an environmental load larger than usual is distributed to other action type performed in advance, it suffices to distribute the environmental load larger than usual, which is caused by an a posteriori action type, as the environmental load of the action type, depending on the action type.

For this purpose, the following arrangement is provided. That is, when the environmental load distribution unit 80 detects that the environmental load of a preset action type exceeds a first threshold (for example, the average value of environmental loads in the past) and that the environmental load of an action type performed afterward exceeds a second threshold (the average value of the action type in the past), an environmental load portion exceeding the second threshold is detected, and the detected surplus is distributed so as to be added to the environmental load of the preset action type.

In the above embodiment, the five actions performed immediately before an evaluation target are targets from which an impact relationship is to be obtained or to which loads are to be distributed. However, the number of actions is not limited to five. In addition, it suffices to set actions performed within a preset time, instead of setting the number of actions in advance, as targets from which an impact relationship is to be obtained or to which loads are to be distributed.

Obviously, the embodiments can be variously modified and changed within the spirit and scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An action evaluation apparatus comprising:
action detection unit which detects an action of a user;
environmental load detection unit which detects a load on an environment which is caused by the action;
first storage unit which stores identification information of the action and the detected load in correspondence with each other;
overload action detection unit which detects a first action which has caused a load exceeding a threshold;
load adjusting unit which adjusts the load which is caused by the first action and a load which is caused by a second action stored in the first storage; and
second storage unit which stores the adjusted load in correspondence with the identification information of the action.

2. The apparatus according to claim 1, which further comprises standard calculation unit which calculates a standard value of a load for each action in the same category on the basis of information stored in the first storage unit, and in which the overload action detection unit detects an action which has caused a load which has exceeded the standard value.

3. The apparatus according to claim 1, wherein the load adjusting unit comprises
overload detection unit which detects an amount by which the load exceeds the threshold, and
addition unit which adds the amount to a load of another action.

4. The apparatus according to claim 1, wherein
the first storage unit stores the identification information of the first action, a detected load, and time information in correspondence with each other, and
the load adjusting unit comprises
a posteriori action overload detection unit which detects, based on information stored in the first storage unit, an action which has caused a load exceeding a threshold from actions performed after the action detected by the overload action detection unit,
overload detection unit which detects an amount by which the load of the action which is detected by the a posteriori action overload detection unit exceeds the threshold, and
addition unit which adds the amount to the load of the first action which is detected by the overload action detection unit.

5. The apparatus according to claim 1, wherein the load adjusting unit comprises
overload detection unit which detecting an amount by which the load exceeds the threshold,
relationship detection unit which obtains a relationship between the second action detected by the overload action detection unit and another action, and
addition unit which adds the amount to a load of another action in accordance with the relationship.

6. The apparatus according to claim 1, wherein
the first storage unit stores the identification information of the second action, a detected load, and time information in correspondence with each other, and
the load adjusting unit comprises
overload detection unit which detects an amount by which the load exceeds the threshold,
totalization unit which totalizes, based on information stored in the first storage unit, actions performed before an action of the same type as that of the action detected by the overload action detection unit, and
addition unit which adds, in accordance with the totalization result, the amount to a load of an action performed before the action detected by the overload action detection unit.

7. The apparatus according to claim 6, wherein the addition unit adds the amount to loads of a plurality of actions performed before the action detected by the overload action detection unit upon being distributed at ratios corresponding to the totalization result.

8. The apparatus according to claim 7, which further comprises information extraction unit which extracts information, of information stored in the first storage unit, which has time information within a range based on time information made to correspond to an action detected by the overload action detection unit, and in which
the totalization unit totalizes actions performed before an action of the same type as that of the action detected by the overload action detection unit for each type on the basis of information extracted by the information extraction unit.

9. The apparatus according to claim 8, further comprising range adjusting unit which widens a range on which the information extraction unit is based when the number of pieces of information extracted by the information extraction unit is less than a preset threshold.

10. The apparatus according to claim 1, further comprising advice output unit which outputting information of an advice based on the adjusted load.

11. The apparatus according to claim 10, wherein the advice output unit comprises
advice storage unit which stores advice information in which a condition associated with a load threshold and an advice are made to correspond to an action type,
selection unit which selects, based on the adjusted load, advice information made to correspond to a matched condition from the advice storage unit for each action type, and
output unit which outputs advice information included in selected advice information.

12. The apparatus according to claim 11, wherein
the advice storage unit stores advice information in which a condition associated with a load threshold, an advice, and a priority level are made to correspond to an action type, and
the selection unit selects advice information made to correspond to a matched condition from the advice storage unit for each action type based on the adjusted load, and selects advice information with the high priority level when a plurality of pieces of advice information are selected.

13. The apparatus according to claim 10, which further comprises timepiece unit which counts a time, and
timing determination unit which determines an output timing of an advice on based on the time, and in which
the advice output unit comprises advice output unit which outputs information of an advice in accordance with a determination result obtained by the determination unit.

14. The apparatus according to claim 10, which further comprises timing determination unit which determines an output timing of an advice based on a current action detected by the action detection unit, and in which
the advice output unit comprises advice output unit which outputs information of an advice in accordance with a determination result obtained by the determination unit.

15. An action evaluation method comprising steps of:
detecting a first action of a user;
detecting a load on an environment which is caused by the first action;
storing identification information of the first action and the detected load in correspondence with each other;
detecting a second action which has caused a load exceeding a threshold;
adjusting a load detected between the second action detected in the step of detecting the second action which has caused the load exceeding the threshold and another action; and
storing the adjusted load in correspondence with the identification information of the first action.
